(19) United States
(12) Patent Application Publication
(10) Pub. No.: US 2021/0056620 A1
(43) Pub. Date: Feb. 25, 2021

(54) MULTI-LENDER CREDIT HISTORY RECORD BLOCKCHAIN

(71) Applicant: Capital One Services, LLC, McLean, VA (US)

(72) Inventors: Qiaochu TANG, The Colony, TX (US); Stephen WYLIE, Carrollton, TX (US); Geoffrey DAGLEY, McKinney, TX (US); Jason HOOVER, Grapevine, TX (US); Micah PRICE, Plano, TX (US)

(73) Assignee: Capital One Services, LLC, McLean, VA (US)

(21) Appl. No.: 16/544,864

(22) Filed: Aug. 19, 2019

(51) Int. Cl. G06Q 40/02; H04L 9/06; G06Q 20/36

(52) U.S. Cl. CPC G06Q 40/025; G06Q 20/363; H04L 9/0637

(57) ABSTRACT

A credit history blockchain wallet of the user account in one or more blocks of a credit history blockchain may be searched to identify a plurality of credit event records associated with a user account responsive to a loan request. A first loan offer may be received for the user account based on the plurality of credit event records in the credit history blockchain. First information associated with the first loan offer may be recorded in the credit history blockchain wallet, the first information associated with the user. An acceptance of the first loan offer may be received from the user account. Second information associated with the accepted first loan offer may be recorded in the credit history blockchain wallet of the user account in the credit history blockchain.

### TECHNICAL FIELD

Embodiments described herein generally relate to management of credit records using a blockchain.

### BACKGROUND

Conventional credit event record systems fail store complete financial records for an individual. As such, these conventional systems provide only a limited set of records that can be used to determine a creditworthiness of the individual. Further, the financial records stored by these conventional systems can be lost, stolen, or otherwise compromised.

### SUMMARY OF THE DISCLOSURE

This disclosure presents various systems, components, and methods related to using a multiple lender (multi-lender) credit history record blockchain. Each of the systems, components, and methods disclosed herein provides one or more advantages over conventional systems, components, and methods.

Various embodiments include receiving a request for a loan from a user account. A credit history blockchain wallet of the user account in one or more blocks of a credit history blockchain may be searched to identify a plurality of credit event records associated with the user account. A first loan offer may be received for the user account based on the plurality of credit event records associated with the user account in the one or more blocks of the credit history blockchain. First information associated with the first loan offer may be recorded in the credit history blockchain wallet in the one or more blocks of the credit history blockchain, the first information associated with the user based on the credit history blockchain wallet of the user account. An acceptance of the first loan offer may be received from the user account. Second information associated with the accepted first loan offer may be recorded in the credit history blockchain wallet of the user account in the one or more blocks of the credit history blockchain, the second information related to at least one of a repayment of the accepted first loan offer, a missed repayment of the accepted first loan offer, and a refinancing of the accepted first loan offer. Other embodiments are disclosed and described.

### BRIEF DESCRIPTION OF THE DRAWINGS

FIG. 1 illustrates an operating environment.

FIG. 2 illustrates a technique for implementing a multiple lender credit request.

FIG. 3 illustrates transactions stored in a credit history record blockchain of FIG. 1 related to the multiple lender credit request of FIG. 2.

FIG. 4 illustrates a logic flow.

FIG. 5 illustrates a storage medium.

FIG. 6 illustrates a computing architecture.

FIG. 7 illustrates a communication architecture.

FIG. 8 illustrates a logical model of a blockchain.

FIG. 9 illustrates a logical model of a message stored in the blockchain of FIG. 8.

### DETAILED DESCRIPTION

Embodiments disclosed herein provide a centralized credit reporting system implemented in a blockchain. Generally, the blockchain provides a centralized, permissioned structure to consolidate a plurality of credit actors and record all credit events for all associated customers. Generally, each customer may have a wallet in the blockchain that is tied to the customer's personal information. Different creditors may add transactions to the wallet of the customer.

To request credit, a customer may submit the request with an indication of the relevant parameters to the blockchain. The blockchain may add a transaction to the customer's wallet that reflects the credit request. The transaction may trigger an event inside the blockchain which notifies one or more potential creditors of the request. Creditors may submit credit responses with approval status and credit terms to the wallet of the user. The user may then send a transaction to the wallet selecting one of the credit responses from the creditors. As the customer makes payments, the creditor may record successful payment transactions to the customer's wallet. Similarly, if the customer misses a payment, defaults, refinances, or takes any other action, a transaction is recorded to the wallet. If the customer has multiple wallets, each wallet may be linked together to form a single wallet via a linking transaction. If fraud is detected in an account, the wallet for the account may be closed.

Advantageously, by providing an immutable log, the blockchain-based system disclosed herein provides credit histories that cannot be fabricated and/or modified, which enhances the security of all data and provides greater assurances of the validity of any data being relied upon by lenders making credit decisions. Furthermore, by centralizing all transactions for a customer to a single location, all credit records for the customer may be accurately identified.

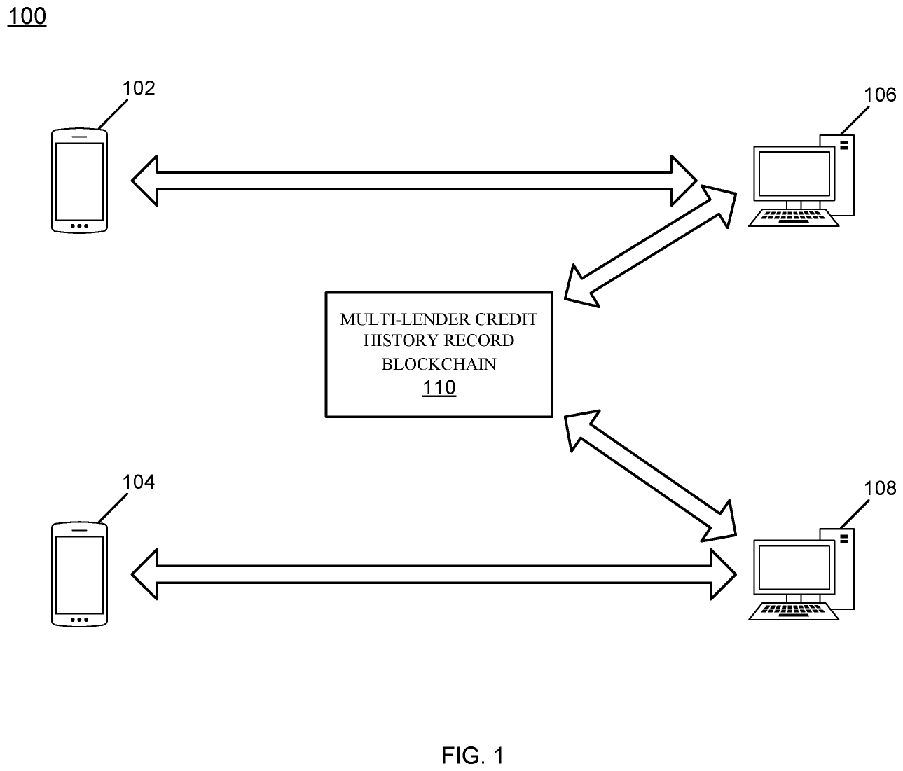

FIG. 1 illustrates an operating environment 100 such as may be representative of various embodiments in which a multiple lender (multi-lender) credit history record blockchain may be implemented. As shown in FIG. 1, the operating environment may include a first user computing device 102, a second user computing device 104, a first entity computing device 106, a second entity computing device 108, and a multi-lender credit history record blockchain 110 (referred to herein as a credit history record blockchain, a credit history blockchain, or a blockchain without intent to limit).

The first and second user computing devices 102 and 104 can each be a desktop, a smartphone, a tablet, a notebook, a laptop, a netbook, or any other computing device capable of communicating with any other computing device. The first and second entity computing devices 106 and 108 can each be a desktop, a smartphone, a tablet, a notebook, a laptop, a netbook; can each be any type of server, computer storage device, computer networking system, cloud-based computing resource or service; or can each be any other type of computing device capable of communicating with any other computing device.

The first and second user computing devices 102 and 104 can each be associated with a user or customer. The users can be private individuals or can represent other entities such as a company (e.g., a corporation). The first and second entity computing devices 106 and 108 can each be associated with any type of financial entity such as, for example, a bank, a lender, a loan processing company, etc.

The credit history record blockchain 110 can be any type of blockchain or distributed ledger system. The credit history record blockchain 110 can operate as a ledger and can store records, data, and/or information related to users of the first and second user computing devices 102 and 104 and/or to the entities related to the first and second entity computing devices 106 and 108. As an example, the credit history record blockchain 110 can store records related to any transaction and/or credit history event related to the user of the first user computing device 102. The records or data can be stored within blocks on the credit history record blockchain 110 and can be searched and/or reviewed by any component, individual, or entity depicted in FIG. 1 (or any entity or user affiliated with any component depicted in FIG. 1).

In various embodiments, the credit history record blockchain 110 can be a private and/or permissioned blockchain. That is, the credit history record blockchain 110 can be restricted to only those individuals or entities that have been authorized to access the credit history record blockchain 110. In various embodiments, access to the credit history record blockchain 110 can be restricted based on a private key associated with a blockchain wallet for a given user account. In some embodiments, the blockchain 110 is a consortium blockchain that has multiple private parties (e.g., the entities related to the first and second entity computing devices 106 and 108) operating in the blockchain 110. Therefore, in such embodiments, the devices 102, 104 may indirectly access the blockchain 110 through the first and second entity computing devices 106 and 108. By restricting the blockchain 110 in such embodiments from direct public access, security of the blockchain 110 and protection of data stored on the blockchain 110 is increased.

In various embodiments, the users of the first and second user computing devices 102 and 104 can each generate a blockchain wallet associated with the credit history record blockchain 110 via the first and second entity computing devices 106 and 108. For example, the user of the first user computing device 102 can generate and store a blockchain wallet on a storage device associated with the first user computing device 102. The blockchain wallet can include information to uniquely identify the user of the first user computing device 102. The blockchain wallet can be used to associate any transaction or other record stored in the credit history record blockchain 110 to the user of the first user computing device 102.

In various embodiments, any and/or all credit events related to the user of the first user computing device 102 can be stored on the credit history record blockchain 110 via the first and second entity computing devices 106 and 108. The credit events can relate to any type of transaction and/or any other type of event or financial information related to a user (e.g., the user of the first user computing device 102). The credit events can be associated with the user based on the blockchain wallet of the user.

By storing any credit event related to the user of the first user computing device 102 on the credit history record blockchain 110, one or more of the entities associated with the first and second entity computing devices 106 and 108 can search and review records related to the credit events to determine a credit of the user and/or a creditworthiness of the user. In turn, one or more of the entities associated with the first and second entity computing devices 106 and 108 can determine whether or not a loan can be offered (and/or under what conditions) to the user based on the searched and/or reviewed credit records for the user that are stored on the credit history record blockchain 110. By storing any credit event related to the user of the first user computing device 102 on the credit history record blockchain 110, the one or more of the entities associated with the first and second entity computing devices 106 and 108 can offer loan terms based on more complete information (e.g., more complete credit event records) for the user than would be otherwise available under conventional credit reporting.

In various embodiments, credit events can be recorded on the credit history record blockchain 110 in a manner that allows a user or individual associated with the stored record to be uniquely identified. In various embodiments, an individual can be identified based on the individual's wallet. In various embodiments, the stored record can include information regarding a credit event that can be reviewed by other entities—information such as, for example, an amount of a loan, a repayment of a loan, a missed payment on a loan, etc. In general, any type of information can be stored in the credit history record blockchain 110 that can be searched (e.g., based on a particular user) and reviewed to develop a full picture on the financial history (and therefore credit history) of an individual.

Further, in various embodiments, the entities associated with the first and second entity computing devices 106 and 108 can store information or records related to any credit history event for the user based on any transaction that occurs with the user. For example, the entity associated with the first entity computing device 106 can provide a loan to the user associated with the first user computing device 102. Any credit event related to the loan can then be recorded on the credit history record blockchain 110 by the entity that offered the loan. Credit events can include, for example, loan repayment details (amount of payments, date of payments, source of payments, overpayments, underpayments, etc.), missed payment details (amount of due payment missed, deadline for payment missed, how many payments missed, reasons for missing payment, etc.), and/or other related loan repayment details (e.g., when refinanced, why refinanced, etc.).

In various embodiments, the monetary transactions related to the loan—for example, providing the loan funds and providing repayment of the loan—can occur outside of the operating environment 100 using conventional financial instruments. For example, loan repayments can be transferred from a bank of a customer to a loan provider through conventional financial channels—while a record of such repayment is recorded in the credit history record blockchain 110.

The operating environment 100, including the setup, use, and/or maintenance of the credit history record blockchain 110 enables the entities associated with the first and second entity computing devices 106 and 108 to have more information available to determine a credit and/or credit worthiness of a particular potential customer. In turn, positive credit events by the potential customer are incentivized. Further, entities can offer more unique and customized loans for customers as more complete records for each potential customer can be provided.

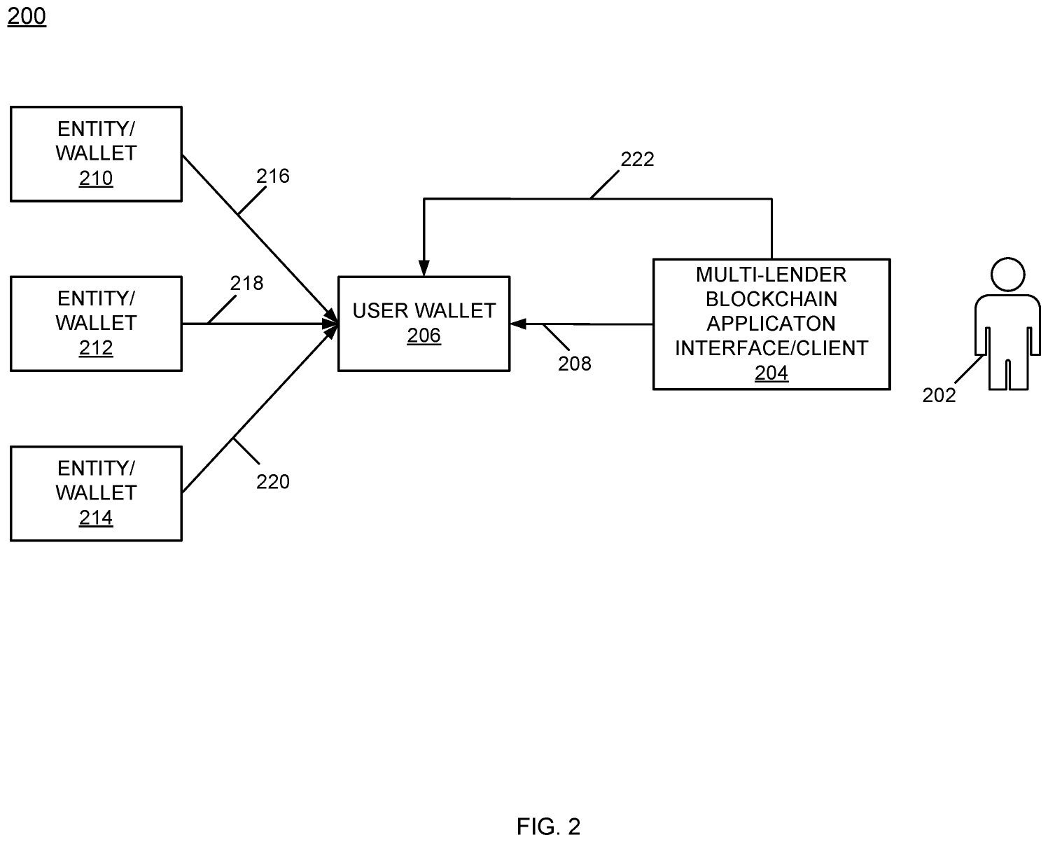

FIG. 2 illustrates an example multi-lender credit request 200. That is, FIG. 2 can represent a technique or process for a multi-lender credit request 200. The multi-lender credit request 200 can be conducted within the operating environment 100. As shown in FIG. 2, a user 202 can interact with a multi-lender blockchain application interface 204. The user 202 can be a user of the first user computing device 102 or second user computing device 104. The blockchain application interface 204 can be provided by a remote computing device and/or network. For example, the blockchain application interface 204 can be a web-based application that is provided to a client computing device (e.g., the first user computing device 102).

In various embodiments, the multi-lender blockchain application interface 204 can include a universal application used by the user 202 to apply for a loan. In various embodiments, the multi-lender blockchain application interface 204 can request information related to a loan for the user 202—for example, an amount of the loan, terms of the loan, information related to the user 202, use of the requested loan funds, etc. The multi-lender blockchain application interface 204 may collect information that may be accepted by multiple entities that operate within the operating environment 100. The multi-lender blockchain application interface 204 may be associated with the credit history record blockchain 110.

In various embodiments, the user 202 may be associated with a blockchain wallet 206. The blockchain wallet 206 may be associated with the credit history record blockchain 110. The blockchain wallet 206 may uniquely identify the user 202 and may be associated with a private key. In various embodiments, the user 202 may interact with the multi-lender blockchain application interface 204 to post a transaction or record on the credit history record blockchain 110 that indicates that the user 202 is requesting a loan and/or other credit 208. In doing so, the user 202 can conduct the transaction and/or ensure a record of the request is added to the credit history record blockchain 110 by using the blockchain wallet 206 to conduct the request. In this manner, the user 202 issues the request for credit 208 in relation to the blockchain wallet 206 that can be posted as a transaction or other record on the credit history record blockchain 110.

Once a record of the request for credit 208 is recorded in the credit history record blockchain 110, a trigger may be sent to entities 210, 212, and 214 such that they are made aware of the request for credit 208. In various embodiments, the credit history record blockchain 110 can be searched for requests for credit and may locate the request for credit 208. In various embodiments, the entities 210, 212, and 214 can be any type of financial institution such as a bank or lender. In an example, the entity 210 can represent a financial institution that operates the first entity computing device 106 and interacts with the credit history record blockchain 110 through the first entity computing device 106. In various embodiments, the entities 210, 212, and 214 can each be associated with a blockchain wallet associated with the credit history record blockchain 110. Although a blockchain wallet is used as a reference example herein, the disclosure is equally applicable to other types of executable code that executes a proprietary function responsive to receiving a user action (e.g. request 208), such as a Hyperledger Fabric peers (that may be unique to one or more entities) and/or a smart contract.

In various embodiments, the request for credit 208 by the user 202 can be recorded as a record in the user wallet 206 of the credit history record blockchain 110. Responsive to the recording of the record in the user wallet 206 as a trigger, the entity 210 can search and locate the request for credit 208. The entity 210, in response, can issue a credit offer 216. The credit offer 216 can be posted as a record on the credit history record blockchain 110 (e.g., as a record in the user wallet 206) and/or can be transmitted directly to the user 202. In various embodiments, the credit offer 216 can be generated by the entity 210 based on prior transactional information and/or credit information (e.g., credit history events) related to the user 202 that are stored in the credit history record blockchain 110.

Prior credit history information of the user 202 can be located by searching the credit history record blockchain 110 for records relating to the blockchain wallet 206. For example, a search of records related to the blockchain wallet 206 can reveal credit events related to the user 202. The credit events can then be used by the entity 210 to generate the credit offer 216. For example, more favorable credit and/or loan terms may be offered based on a higher determined credit rating for the user 202 based on a review of credit events for the user 202 stored on the credit history record blockchain 110.

In a similar manner, the entity 212 may issue a credit offer 218 that can be posted as a record on the credit history record blockchain 110 (e.g., as a record in the user wallet 206) and/or can be transmitted directly to the user 202. The entity 214 may also issue a credit offer 220 that can be posted as a record on the credit history record blockchain 110 and/or can be transmitted directly to the user 202. The user 202 may then review the credits offers 216, 218, and 220 to determine which to select.

In various embodiments, a decision by the user 202 on which of the credit offers 216, 218, and 220 to select can be recorded as a transaction (e.g., as a credit offer acceptance 222) on the credit history record blockchain 110 (e.g., as a record in the user wallet 206). Further, in various embodiments, any transaction related to the accepted offer can be recorded as a transaction on the credit history record blockchain 110. For example, a successfully made payment, a missed payment, a refinancing of the accepted offer, etc. can each be recorded as transactions on the credit history record blockchain 110. In this manner, credit events related to the accepted offer are stored on the credit history record blockchain 110 that can be used to build a credit history for the user 202.

In various embodiments, to determine the credit offer 216, the entity 210 may request additional information from the user 202 other than any data or information provided on through the application interface 204. As an example, the entity 210 may request the user 202 to fill out a form (e.g., an on-line form) with additional requested information to facilitate generation of the credit offer 210.

In some embodiments, the user may have multiple blockchain wallets 206. In embodiments, the multiple wallets 206 may be linked together by the blockchain 110 via a transaction written to the blockchain 110. The transaction may specify each wallet 206 and that the wallets 206 are being linked.

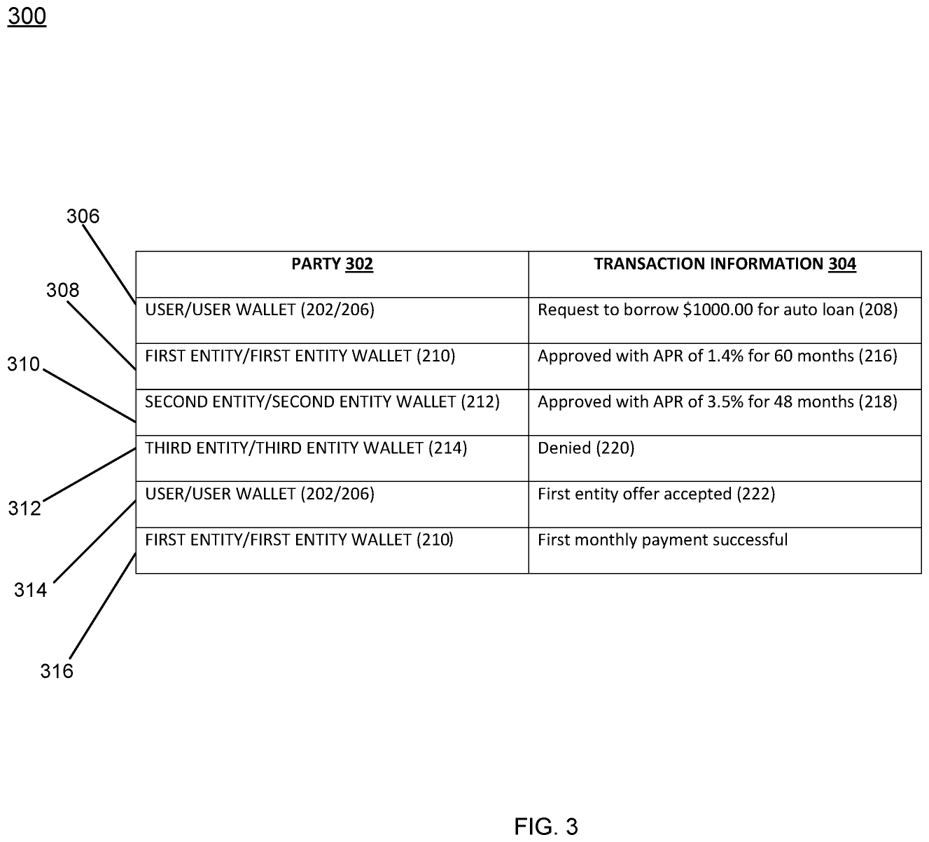

FIG. 3 illustrates example transactions 300 related to the multi-lender credit request 200. The example transactions 300 can represent information stored as records within the multi-lender credit request 200.

As shown in FIG. 3, the transactions 300 can specify a party 302 and related transaction information 304. The transactions 300 can include a first transaction 306—for example, a transaction conducted by the user 202/through the blockchain wallet 206 requesting an amount of money or credit for a certain purpose. The first transaction 306 can reflect information regarding the request for credit 208. A second transaction 308 can be information related to the credit offer 216 from the entity 210—for example, a record of whether the credit request 208 was approved and under what terms (e.g., a loan rate, a loan term, etc.).

A third transaction 310 can be information related to the credit offer 218 from the entity 212—for example, a record of whether the credit request 208 was approved and under what terms (e.g., a loan rate, a loan term, etc.). A fourth transaction 312 can be information related to the credit offer 220 from the entity 214—for example, a record of whether the credit request 208 was approved and under what terms (e.g., a loan rate, a loan term, etc.).

As described herein, the transactions/records 308, 310, and 312 can be stored in the credit history record blockchain 110 (e.g., as respective records in the user wallet 206) and located by the user 202. The user 202 can review the transactions 308, 310, and 312 to determine a credit offer (e.g., one of the credit offers 216, 218, 220) to accept (and which to reject). An indication of what credit offer was selected can be stored as a record in the credit history record blockchain 110—for example, as a transaction/record 314 specifying that the credit offer 216 was selected.

As further shown in FIG. 3, a transaction/record 316 can be stored in the credit history record blockchain 110 that relates to a credit event for the selected loan offer. For example, the record 316 can specify that a first monthly payment was successfully made by the user 202. In various embodiments, the record 316 can be stored on the credit history record blockchain 110 by the entity 210. The record 316 can be located and searched by other entities to develop a credit history for the user 202. The record 316 can include an indication that the record 316 relates to the user 202 and/or the blockchain wallet 206.

In various embodiments, the information related to the transactions 300 can be stored in the credit history record blockchain 110 and can be located by any individual or components depicted in FIG. 1 or FIG. 2. In various embodiments, the information related to the transactions 300 can be encrypted and can be decrypted to those entities having access to credit history record blockchain 110 when provided as a private/permissioned blockchain. In various embodiments, the information related to the transactions 300 or any portion thereof can be stored as part of a digital signature for any record stored in the credit history record blockchain 110.

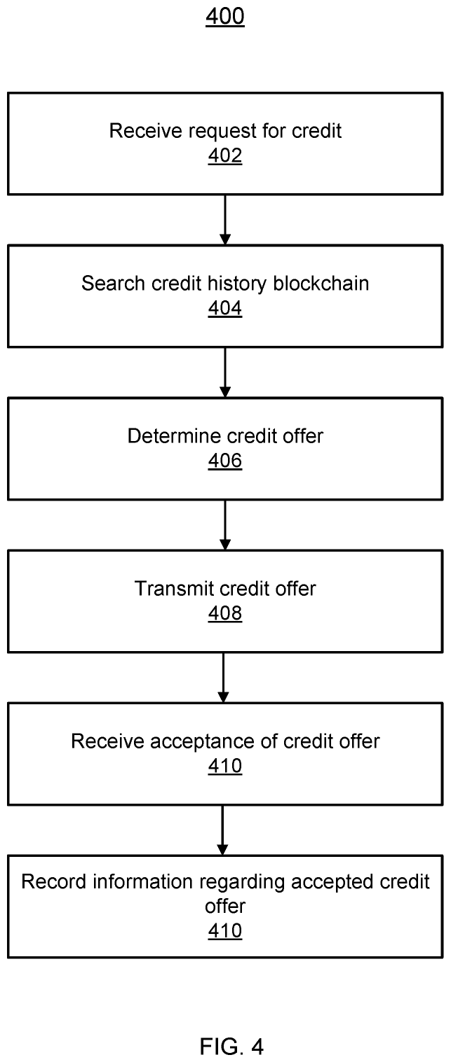

FIG. 4 illustrates an example of a logic flow 400 that may be representative of techniques for implementing a multi-lender credit history record blockchain. For example, the logic flow 400 may be representative of operations that may be performed in various embodiments by any constituent component of the operating environment 100 depicted in FIG. 1.

At 402, a request for a loan or for credit from a user or customer can be received. In various embodiments, the request can be received as a transaction record stored on a credit history record blockchain with the transaction record associated with a blockchain wallet of the user.

At 404, a search of the credit history blockchain can be conducted. The search can be conducted to attempt to locate credit events (e.g., past credit events) associated with the user. As a result of the search, one or more credit events related to the user can be collected and reviewed. The credit events can each be stored as records on the credit history blockchain (e.g., as records in the user wallet in the blockchain).

At 406, a loan or credit offer to the user can be determined. The loan offer can be determined based on the credit event records associated with the user located at 404. Based on the information collected at 404, a credit history of the user can be established. The credit history can be used to determine the credit worthiness of the user and/or a level of risk relating to lending money to the user.

At 408, the determined loan offer can be transmitted to the user. Loan offers can be provided to the user from multiple lenders. Each lender can store an associated loan offer as a record on the credit history blockchain (e.g., as a record in the user wallet). The loan offers may be confidential and may be encrypted and may be decrypted only by the user (e.g., by using the private key associated with the user wallet).

At 410, a loan offer can be accepted and an acceptance of the loan offer can be received. In various embodiments, the acceptance of the loan offer can be received as a transaction record stored on the credit history record blockchain with the transaction record associated with the blockchain wallet of the user.

At 412, information associated with the accepted loan offer can be recorded on the credit history blockchain. As an example, the recorded information can identity the user and/or terms of the loan in the user wallet. Further, the recorded information can relate to transactions for replaying the loan—for example, a repayment of the accepted loan offer, a missed repayment of the accepted loan offer, and/or a refinancing of the accepted loan offer. In this manner, a credit history of the user as it relates to the accepted loan offer can be built based on records stored by the lender on the credit history blockchain.

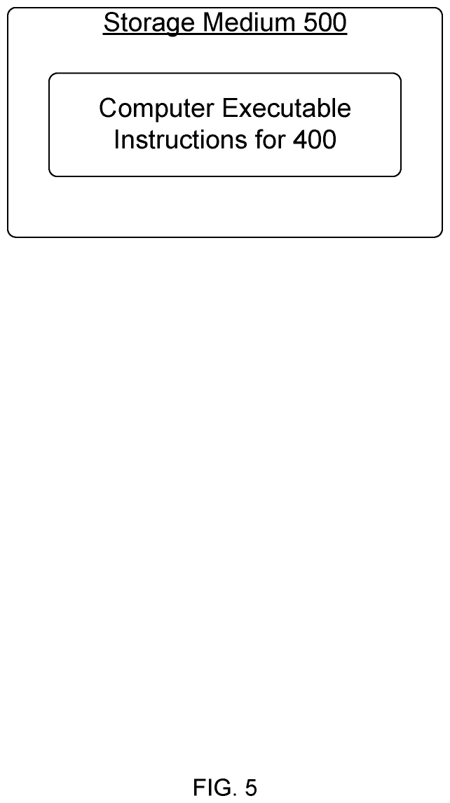

FIG. 5 illustrates a storage medium 500. Storage medium 500 may represent an implementation of a storage device of any computing device that may operate as a node within the mesh network 100 of FIG. 1. The storage medium 500 can comprise any non-transitory computer-readable storage medium or machine-readable storage medium. In various embodiments, the storage medium 500 can comprise a physical article of manufacture. In various embodiments, storage medium 8500 can store computer-executable instructions, such as computer-executable instructions to implement one or more of logic flows or operations described herein, such as the logic flow 400 of FIG. 4. In various embodiments, storage medium 500 can store computer-executable instructions, such as computer-executable instructions to implement any of the functionality described herein in relation to any described device, system, or apparatus. Examples of a computer-readable storage medium or machine-readable storage medium can include any tangible media capable of storing electronic data. Examples of computer-executable instructions can include any type of computer readable code.

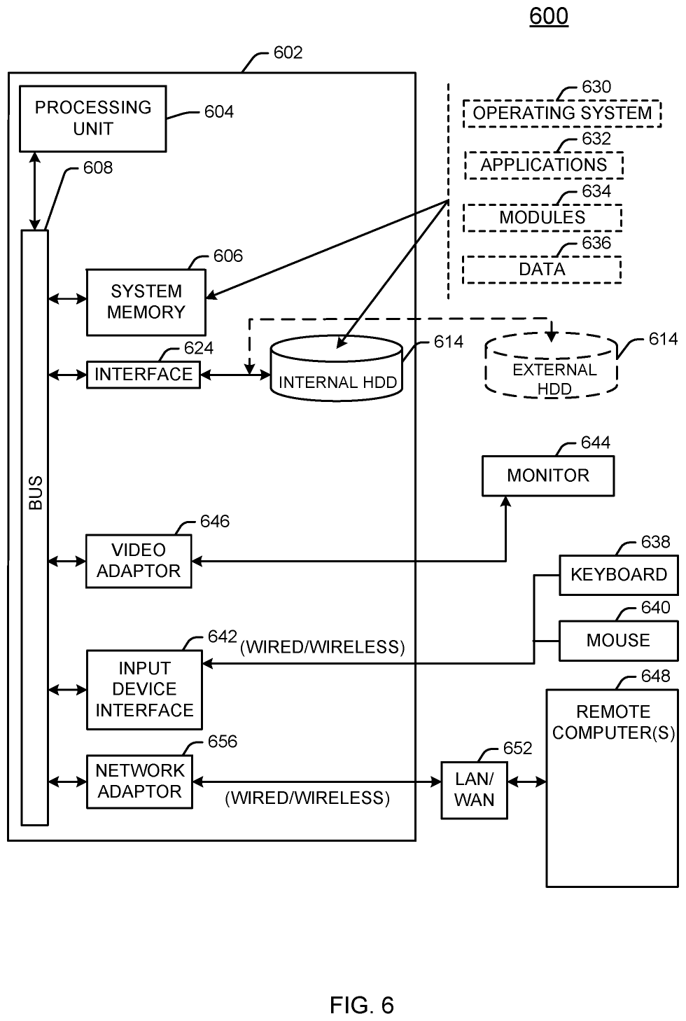

FIG. 6 illustrates a computing architecture 600 that can implement various embodiments described herein. In various embodiments, the computing architecture 600 can comprise or be implemented as part of an electronic device and/or a computing device. In various embodiments, the computing architecture 600 can represent an implementation of any constituent component of operating environment 100 depicted in FIG. 1. One or more of the constituent components of the computing architecture 600, and/or any constituent component of the operating environment 100, can be implemented in hardware, software, or any combination thereof including implementation based on a storage device (e.g., a memory unit) and logic, at least a portion of which is implemented in circuitry and coupled to the storage device. The logic can be or can include a processor or controller component.

The computing architecture 600 can include various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth.

As shown in FIG. 6, the computing architecture 600 can comprise a computer 602 having a processing unit 604, a system memory 606 and a system bus 608. The processing unit 604 can be any of various commercially available processors or can be a specially designed processor.

The system bus 608 provides an interface for system components including, but not limited to, an interface between the system memory 606 and the processing unit 604. The system bus 608 can be any of several types of bus structure that may further interconnect to a memory bus (with or without a memory controller), a peripheral bus, and a local bus using any of a variety of commercially available bus architectures.

The system memory 606 can include any type of computer-readable storage media including any type of volatile and non-volatile memory. The computer 602 can include any type of computer-readable storage media including an internal (or external) hard disk drive (HDD) 614. In various embodiments, the computer 602 can include any other type of disk drive such as, for example, a magnetic floppy disk and/or an optical disk drive. The HDD 614 can be connected to the system bus 608 by a HDD interface 624.

In various embodiments, any number of program modules can be stored in the drives and memory units 606 and/or 614 such as, for example, an operating system 630, one or more application programs 632, other program modules 634, and program data 636.

A user can enter commands and information into the computer 602 through one or more wired/wireless input devices such as, for example, a keyboard 638 and a pointing device, such as a mouse 640. These and other input devices can be connected to the processing unit 604 through an input device interface 642 that is coupled to the system bus 608. A monitor 644 or other type of display device can also be connected to the system bus 608 via an interface, such as a video adaptor 646. The monitor 644 may be internal or external to the computer 602

The computer 602 may operate in a networked environment using logical connections via wired and/or wireless communications to one or more remote computers, such as a remote computer 648. The remote computer 648 can be a workstation, a server computer, a router, a personal computer, portable computer, microprocessor-based entertainment appliance, a smartphone, a tablet, a peer device or other common network node, and typically includes many or all of the elements described relative to the computer 602. The logical connections depicted include wired and/or wireless connectivity to networks 652 such as, for example, a local area network (LAN) and/or larger networks, for example, a wide area network (WAN). Networks 652 can provide connectivity to a global communications network such as, for example, the Internet. A network adapter 656 can facilitate wired and/or wireless communications to the networks 652. The computer 602 is operable to communicate over any known wired or wireless communication technology, standard, or protocol according to any known computer networking technology, standard, or protocol.

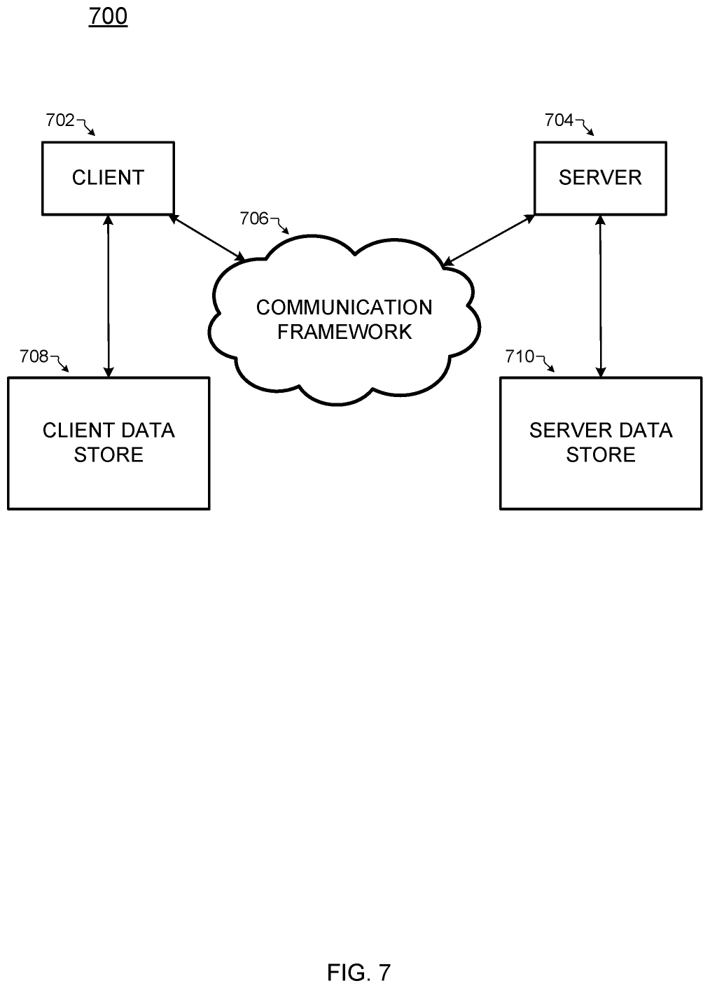

FIG. 7 illustrates a block diagram of a communication architecture 700. The communication architecture 700 can implement various embodiments described herein. As shown in FIG. 7, the communication architecture 700 comprises one or more clients 702 and servers 704. One of the clients 702 and/or one of the servers 704 can represent any constituent component of the operating environment 100 depicted in FIG. 1.

The client 702 and the server 704 can be operatively connected to a client data store 708 and a server data store 710, respectively, that can be employed to store information local to the respective client 702 and server 704. In various embodiments, the client 702 and/or the server 704 can implement one or more of logic flows or operations described herein.

The client 702 and the server 704 can communicate data or other information between each other using a communication framework 706. The communications framework 706 can implement any known communications technique or protocol. The communications framework 706 can be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators), or any combination thereof. The communications framework 706 can operate over any communication media according to any networking technology including any wired or wireless communications standard or protocol, or any combination thereof.

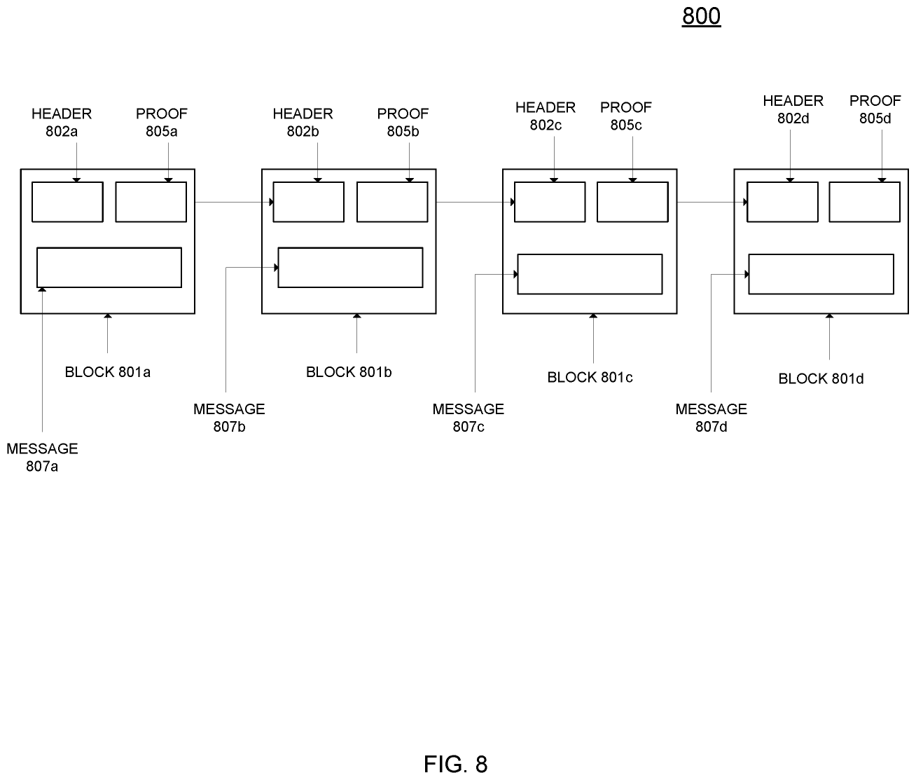

FIG. 8 depicts a logical model 800 of an exemplary blockchain, consistent with disclosed embodiments. The blockchain may comprise blocks, such as blocks 801a-801d. Blocks may include messages, such as message 807a-807d. Each message 807a-807d may comprise one or more messages. Generally, blocks may include a header, such as headers 802a-802d, which uniquely identifies each block. The headers 802a-802d may include a hash value generated by a hash function. A hash function is any function that can be used to map input data of arbitrary size to a hash value of a fixed size. For example, a header may include at least one of the previous block's hash value, a hash value generated based on any messages in the block (e.g., a Merkle root), and a timestamp. Consistent with disclosed embodiments, blocks added to a blockchain described herein may satisfy at least one of a proof-of-work condition and a digital signature condition. For example, the headers 802a-802d may include a nonce chosen to ensure the header satisfies the proof-of-work condition. As a non-limiting example, the proof-of-work condition may require the hash of the header fall within a predetermined range of values. As an additional example, the header may be digitally signed with a cryptographic key of an authorized system, and the digital signature may be included in the header. This digital signature may be verified using an available key. The blocks may also include proof components, such as proof components 805a-805d. As an example, the nonce can comprise the proof components 805.

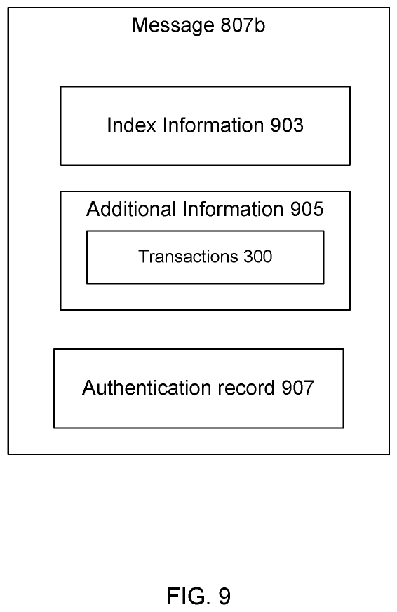

FIG. 9 depicts a logical model of a message 807b stored in a blockchain (e.g., an element of blockchain depicted in FIG. 8), consistent with disclosed embodiments. In some embodiments, message 807b may comprise index information 903. In certain aspects, index information 903 may comprise information identifying a user. For example, index information 903 may be at least one of a full name, email address, phone number, or other non-sensitive personal information of the user. In various aspects, index information 903 may include one or more references to earlier blocks in the private blockchain. For example, index information 903 may include one or more references to one or more earlier blocks associated with the same user. A reference may include, as a non-limiting example, a hash of a preceding block in the blockchain associated with the same user. In some aspects, index information 903 may be obfuscated or encrypted according to methods known to one of skill in the art. For example, index information 903 may be encrypted with a cryptographic key. As an additional example, index information 903 may comprise a hash of the at least one of a full name, email address, phone number, or other non-sensitive personal information of the user.

Message 807b may comprise additional information 905, consistent with disclosed embodiments. The additional information 905 can be, for example, metadata or other information related to a transaction conducted between entities in the operating environment 100 (e.g., may provide public keys for certain entities operating in the operating environment 100). For example, the additional information 905 may include one or more transaction records for a user wallet associated with a user account. One example of such transaction records is the transaction records 300 and/or 306-316 depicted in FIG. 3. In various aspects, additional information 905 may be obfuscated or encrypted according to methods known to one of skill in the art.

Message 807b may comprise authentication record 907, consistent with disclosed embodiments. In some aspects, authentication record 907 may comprise information enabling subsequent auditing of transactions. For example, authentication record 907 may identify at least one entity of the operating environment 100. In some aspects, authentication record 907 may be obfuscated or encrypted according to methods known to one of skill in the art. For example, authentication record 907 may be encrypted with a cryptographic key.

Cryptographic keys may be used to encrypt elements of messages in blocks, consistent with disclosed embodiments. In some aspects, such cryptographic keys may be associated with nodes of the operating environment 100. In various aspects, at least some of the cryptographic keys may be associated with authorized nodes. Corresponding cryptographic keys may be available to decrypt the encrypted message elements, consistent with disclosed embodiments. For example, when an element of a message in a block is encrypted with a symmetric key, the same symmetric key may be available for decrypting the encrypted element. As another example, when an element of a message in a block is encrypted with a private key, a corresponding public key may be available for decrypting the encrypted element, or when an element of a message in a block is encrypted with a public key, a corresponding private key may be available for decrypting the encrypted element.

Various embodiments described herein may comprise one or more elements. An element may comprise any structure arranged to perform certain operations. Each element may be implemented as hardware, software, or any combination thereof. Any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

In various instances, for simplicity, well-known operations, components, and circuits have not been described in detail so as not to obscure the embodiments. It can be appreciated that the specific structural and functional details disclosed herein may be representative and do not necessarily limit the scope of the embodiments.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

1. A computing device, comprising:
a processor circuit; and
a memory storing instructions which when executed by the processor circuit cause the processor circuit to:
receive a request for a loan from a user account, the request specifying an amount of the requested loan, a purpose of the requested loan, and a date of the requested loan;
store an indication of the request in a first credit history blockchain wallet of the user account in one or more blocks of a credit history blockchain, the stored indication to comprise the amount, the purpose, and the date of the requested loan;
responsive to storing the indication of the request, transmit, by the credit history blockchain, a trigger to a plurality of creditors, the trigger specifying the request for the loan, each of the creditors associated with a respective blockchain wallet in one or more blocks of the credit history blockchain;
search the first credit history blockchain wallet of the user account in the one or more blocks of the credit history blockchain to identify a first plurality of credit event records associated with the user account;
receive, from a first creditor of the plurality of creditors and responsive to the trigger, a first loan offer of a plurality of loan offers for the user account based on the first plurality of credit event records associated with the user account in the one or more blocks of the credit history blockchain;
record first information associated with the first loan offer in the first credit history blockchain wallet in the one or more blocks of the credit history blockchain, the first information associated with the user based on the first credit history blockchain wallet of the user account;
receive an acceptance of the first loan offer from the user account;
record the received acceptance of the first loan offer as a first transaction in the first credit history blockchain wallet of the user account in the one or more blocks of the credit history blockchain;
record second information associated with the accepted first loan offer in the first credit history blockchain wallet of the user account in the one or more blocks of the credit history blockchain, the second information related to a repayment of the accepted first loan offer, a missed repayment of the accepted first loan offer, and a refinancing of the accepted first loan offer, wherein an indication of the repayment of the accepted first loan offer is received from a loan provider distinct from the first creditor;
determine that a second credit history blockchain wallet in one or more blocks of the credit history blockchain includes a second plurality of credit event records associated with the user account;
link the first and second credit history blockchain wallets by recording a linking transaction in at least one block of the credit history blockchain;
detect fraud associated with the user account; and
close the linked first and second credit history blockchain wallets based on the detected fraud associated with the user account.

2. The computing device of claim 1, the one or more blocks of the first credit history blockchain wallet to comprise at least a header and a message, the message to store at least a portion of the first credit history blockchain wallet of the user account.

3. The computing device of claim 2, the recorded credit event for the request to relate to a second transaction based on the first credit history blockchain wallet of the user account, the second transaction to indicate, for the first loan offer: a loan amount, a date for the loan, and a purpose of the loan.

4. The computing device of claim 1, the memory storing instructions which when executed by the processor circuit cause the processor circuit to:
receive the plurality of loan offers for the user account from the plurality of creditors responsive to the trigger; and
record information associated with each loan offer in a respective transaction in the first credit history blockchain wallet of the user account in the one or more blocks of the credit history blockchain.

5. The computing device of claim 1, the credit history blockchain to comprise a private credit history blockchain restricted to authorized entities, the credit history blockchain to generate the blocks of the credit history blockchain.

6. The computing device of claim 5, wherein authorized entities are provided access to the private credit history blockchain based on a private key, the memory storing instructions which when executed by the processor circuit cause the processor circuit to:
receive a second request for a second loan from the user account;
receive a second plurality of loan offers for the user account based on the first and second plurality of credit event records associated with the user account in the linked first and second credit history blockchain wallets;
record the second plurality of loan offers in one or more blocks of the blockchain for the linked first and second credit history blockchain wallets;
receive an acceptance of one of the second plurality of loan offers from the user account; and
record information associated with the accepted loan offer of the second plurality of loan offers in one or more blocks of the blockchain for the linked first and second credit history blockchain wallets.

7. The computing device of claim 1, wherein the linking transaction specifies the first credit history blockchain wallet, the second credit history blockchain wallet, and that the first and second credit history blockchain wallets are linked.

8. The computing device of claim 1, the memory storing instructions which when executed by the processor circuit cause the processor circuit to:
determine the first loan offer based on information directly received from the user account and not stored on the credit history blockchain.

9. A method, comprising:
receiving, by a computer processor, a request for a loan from a user account, the request specifying an amount of the requested loan, a purpose of the requested loan, and a date of the requested loan;
storing, by the processor, an indication of the request in a first credit history blockchain wallet of the user account in one or more blocks of a credit history blockchain, the stored indication to comprise the amount, the purpose, and the date of the requested loan:
responsive to storing the indication of the request, transmitting, by the credit history blockchain, a trigger to a plurality of creditors, the trigger specifying the request for the loan, each of the creditors associated with a respective blockchain wallet in one or more blocks of the credit history blockchain;
searching, by the processor, the first credit history blockchain wallet of the user account in the one or more blocks of the credit history blockchain to identify a first plurality of credit event records associated with the user account;
receiving, by the processor from a first creditor of the plurality of creditors and responsive to the trigger, a first loan offer of a plurality of loan offers for the user account based on the first plurality of credit event records associated with the user account in the one or more blocks of the credit history blockchain;
recording, by the processor, first information associated with the first loan offer in the first credit history blockchain wallet in the one or more blocks of the credit history blockchain, the first information associated with the user based on the first credit history blockchain wallet of the user account;
receiving, by the processor, an acceptance of the first loan offer from the user account;
recording, by the processor, the received acceptance of the first loan offer as a first transaction in the first credit history blockchain wallet of the user account in the one or more blocks of the credit history blockchain;
recording, by the processor, second information associated with the accepted first loan offer in the first credit history blockchain wallet of the user account in the one or more blocks of the credit history blockchain, the second information related to at least one of a repayment of the accepted first loan offer, a missed repayment of the accepted first loan offer, and a refinancing of the accepted first loan offer, wherein an indication of the repayment of the accepted first loan offer is received from a loan provider distinct from the first creditor;
determining, by the processor, that a second credit history blockchain wallet in one or more blocks of the credit history blockchain includes a second plurality of credit event records associated with the user account;
linking, by the processor, the first and second credit history blockchain wallets by recording a linking transaction in at least one block of the credit history blockchain;
detecting, by the processor, fraud associated with the user account; and
closing, by the processor, the linked first and second credit history blockchain wallets based on the detected fraud associated with the user account.

10. The method of claim 9, the one or more blocks of the first credit history blockchain wallet to comprise at least a header and a message, the message to store at least a portion of the first credit history blockchain wallet of the user account.

11. The method of claim 10, the recorded credit event for the request to relate to a second transaction based on the first credit history blockchain wallet of the user account, the second transaction to indicate, for the first loan offer: a loan amount, a date for the loan, and a purpose of the loan.

12. The method of claim 9, further comprising:
receiving, by the processor, the plurality of loan offers for the user account from the plurality of creditors responsive to the trigger; and
recording, by the processor, information associated with each loan offer in a respective transaction in the first credit history blockchain wallet of the user account in the one or more blocks of the credit history blockchain.

13. The method of claim 9, the credit history blockchain to comprise a private credit history blockchain restricted to authorized entities.

14. The method of claim 13, wherein authorized entities are provided access to the private credit history blockchain based on a private key, the method further comprising:
receiving, by the processor, a second request for a second loan from the user account;
receiving, by the processor, a second plurality of loan offers for the user account based on the first and second plurality of credit event records associated with the user account in the linked first and second credit history blockchain wallets;
recording, by the processor, the second plurality of loan offers in one or more blocks of the blockchain for the linked first and second credit history blockchain wallets;
receiving, by the processor, an acceptance of one of the second plurality of loan offers from the user account; and
recording, by the processor, information associated with the accepted loan offer of the second plurality of loan offers in one or more blocks of the blockchain for the linked first and second credit history blockchain wallets.

15. The method of claim 9, the credit history blockchain to generate the blocks of the credit history blockchain, the method further comprising searching the one or more blocks of the credit history blockchain based on the credit history blockchain wallet of the user account, wherein the linking transaction specifies the first credit history blockchain wallet, the second credit history blockchain wallet, and that the first and second credit history blockchain wallets are linked.

16. The method of claim 9, further comprising determining the first loan offer based on information directly received from the user account and not stored on the credit history blockchain.

17. A non-transitory computer-readable medium comprising instructions that, in response to being executed on a computing device, cause the computing device to:
receive a request for a loan from a user account, the request specifying an amount of the requested loan, a purpose of the requested loan, and a date of the requested loan;
store an indication of the request in a first credit history blockchain wallet of the user account in one or more blocks of a credit history blockchain, the stored indication to comprise the amount, the purpose, and the date of the requested loan;
responsive to storing the indication of the request, transmit, by the credit history blockchain, a trigger to a plurality of creditors, the trigger specifying the request for the loan, each of the creditors associated with a respective blockchain wallet in one or more blocks of the credit history blockchain;
search the first credit history blockchain wallet of the user account in the one or more blocks of the credit history blockchain to identify a first plurality of credit event records associated with the user account;
receive, from a first creditor of the plurality of creditors and responsive to the trigger, a first loan offer of a plurality of loan offers for the user account based on the first plurality of credit event records associated with the user account in the one or more blocks of the credit history blockchain;
record first information associated with the first loan offer in the first credit history blockchain wallet in the one or more blocks of the credit history blockchain, the first information associated with the user based on the first credit history blockchain wallet of the user account;
receive an acceptance of the first loan offer from the user account;
record the received acceptance of the first loan offer as a first transaction in the first credit history blockchain wallet of the user account in the one or more blocks of the credit history blockchain;
record second information associated with the accepted first loan offer in the first credit history blockchain wallet of the user account in the one or more blocks of the credit history blockchain, the second information related to at least one of a repayment of the accepted first loan offer, a missed repayment of the accepted first loan offer, and a refinancing of the accepted first loan offer, wherein an indication of the repayment of the accepted first loan offer is received from a loan provider distinct from the first creditor;
determine that a second credit history blockchain wallet in one or more blocks of the credit history blockchain includes a second plurality of credit event records associated with the user account;
link the first and second credit history blockchain wallets by recording a linking transaction in at least one block of the credit history blockchain;
detect fraud associated with the user account; and
close the linked first and second credit history blockchain wallets based on the detected fraud associated with the user account.

18. The non-transitory computer-readable medium of claim 17, the one or more blocks of the first credit history blockchain wallet to comprise at least a header and a message, the message to store at least a portion of the first credit history blockchain wallet of the user account, wherein the linking transaction specifies the first credit history blockchain wallet, the second credit history blockchain wallet, and that the first and second credit history blockchain wallets are linked.

19. The non-transitory computer-readable medium of claim 17, the credit history blockchain to comprise a private credit history blockchain restricted to authorized entities, wherein authorized entities are provided access to the private credit history blockchain based on a private key, further comprising instructions which when executed by the computing device cause the computing device to:
receive a second request for a second loan from the user account;
receive a second plurality of loan offers for the user account based on the first and second plurality of credit event records associated with the user account in the linked first and second credit history blockchain wallets;
record the second plurality of loan offers in one or more blocks of the blockchain for the linked first and second credit history blockchain wallets;
receive an acceptance of one of the second plurality of loan offers from the user account; and
record information associated with the accepted loan offer of the second plurality of loan offers in one or more blocks of the blockchain for the linked first and second credit history blockchain wallets.

20. The non-transitory computer-readable medium of claim 17, further comprising instructions which when executed by the computing device cause the computing device to:
transmit a request to the user account for additional information not recorded on the credit history blockchain;
receive the plurality of loan offers for the user account from the plurality of creditors responsive to the trigger; and
record information associated with each loan offer in a respective transaction in the first credit history blockchain wallet of the user account in the credit history blockchain.
